(19) United States
(12) Patent Application Publication
(10) Pub. No.: US 2020/0078880 A1
(43) Pub. Date: Mar. 12, 2020

(54) SELF-STANDING TOOL

(71) Applicant: Pro-Iroda Industries, Inc., Taichung City (TW)

(72) Inventor: WEI CHENG WU, Taichung City (TW)

(21) Appl. No.: 16/406,051

(22) Filed: May 8, 2019

(30) Foreign Application Priority Data
Sep. 12, 2018 (TW) 107132131

(51) Int. Cl. B23K 3/02; B23K 3/03

(52) U.S. Cl. CPC B23K 3/027; B23K 3/0346

(57) ABSTRACT

A self-standing tool includes a body and a tool head. The body includes front and rear ends spaced from each other along a longitudinal axis. The body further includes a lamp seat projecting from an outer periphery thereof surrounding the longitudinal axis. A side of the lamp seat distant from the body has a supporting portion. The center of gravity of the body is located between the rear end and a virtual reference plane extending perpendicularly to the longitudinal axis and passing through the supporting portion. A lighting member is disposed on a side of the lamp seat adjacent to the front end. The tool head includes a first end connected to the front end and a second end distant from the body. The second end of the tool head has a head end located in a projection area of light emitted from the lighting member.

### BACKGROUND OF THE INVENTION

The present invention relates to a tool and, more particularly, to a self-standing tool.

A soldering iron includes a front end emitting high heat to permit a user to proceed with soldering operations or the like. Since the temperature at the front end of the soldering iron is extremely high, the soldering iron must be placed on a stand during the periods of preheating and temporary non-use or after use. This can avoid the soldering iron from rolling, thereby preventing damage to articles or the table surface near the high-temperature soldering iron and preventing injury of the user. Taiwan Utility Model No. M265152 discloses a simple soldering iron stand including a stand, a receiving box, and a cleaning article. A central portion of the stand is cut to form a substantially X-shaped supporting board which can be directly folded upwards two times to form a simple stand.

However, the stand must be prepared every time the soldering iron is used. Furthermore, the soldering operation must be proceeded in a bright area for safety purposes, avoiding the light from being blocked by the soldering iron or the user. Thus, a lamp is required.

Thus, a need exists for a self-standing soldering iron that overcomes the above drawbacks.

### BRIEF SUMMARY OF THE INVENTION

The primary objective of the present invention is to provide a self-standing tool including a body and a tool head. The body extends along a longitudinal axis and includes a front end and a rear end spaced from the front end along the longitudinal axis. The body further includes a lamp seat projecting from an outer periphery thereof surrounding the longitudinal axis. A side of the lamp seat distant from the body has a supporting portion. The lamp seat includes a virtual reference plane extending perpendicularly to the longitudinal axis and passing through the supporting portion. The center of gravity of the body is located between the virtual reference plane and the rear end. A lighting member is disposed on a side of the lamp seat adjacent to the front end. The tool head includes a first end connected to the front end of the body and a second end distant from the body. The second end of the tool head has a head end located in a projection area of light emitted from the lighting member.

In an example, the light emitted from the lighting member has a virtual projection axis passing through the head end.

In an example, the maximum spacing between any point located between the virtual reference plane and the rear end on a side of the body adjacent to the lamp seat and the longitudinal axis in a radial direction perpendicular to the longitudinal axis is smaller than a spacing between the supporting portion and the longitudinal axis in a radial direction perpendicular to the longitudinal axis.

In an example, the body has an integral projection projecting therefrom to form the lamp seat.

In an example, the body further includes a switch on the outer periphery thereof, and the switch is located opposite to the lamp seat.

In an example, the supporting portion is planar.

In an example, the lamp seat is located adjacent to the front end.

In an example, the tool head extends along the longitudinal axis.

The present invention will become clearer in light of the following detailed description of illustrative embodiments of this invention described in connection with the drawings.

### DESCRIPTION OF THE DRAWINGS

FIG. 1 is a perspective view of a self-standing tool of an embodiment according to the present invention.

FIG. 2 is a side view of the self-standing tool placed on a platform and in use.

FIG. 3 is a front view of the self-standing tool placed on the platform and in use.

FIG. 4 is a partial, side elevational view of the self-standing tool in use, with a lighting member activated.

### DETAILED DESCRIPTION OF THE INVENTION

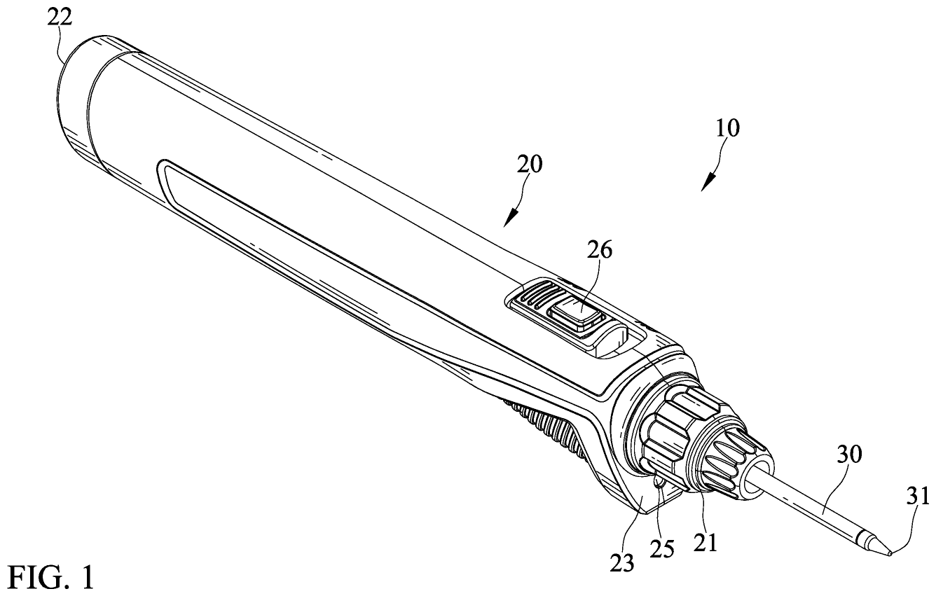

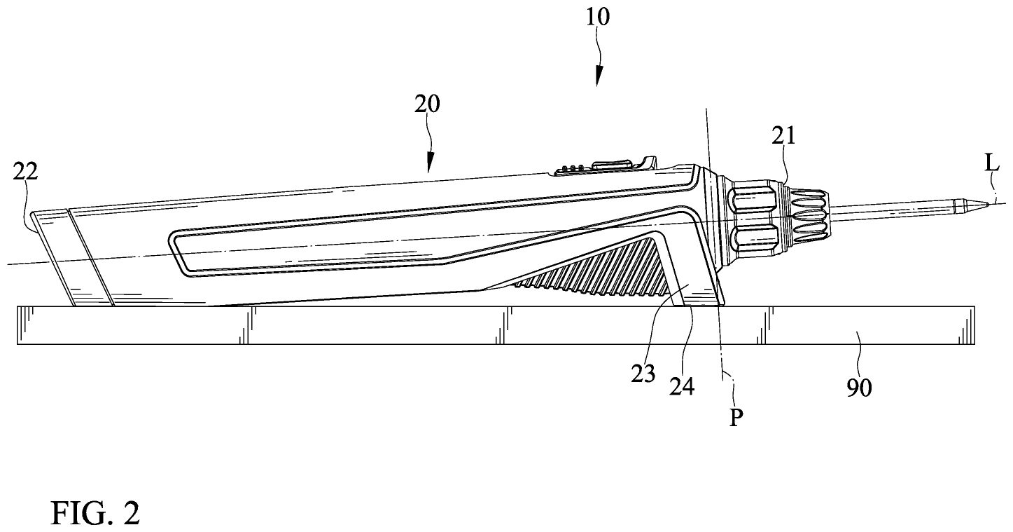

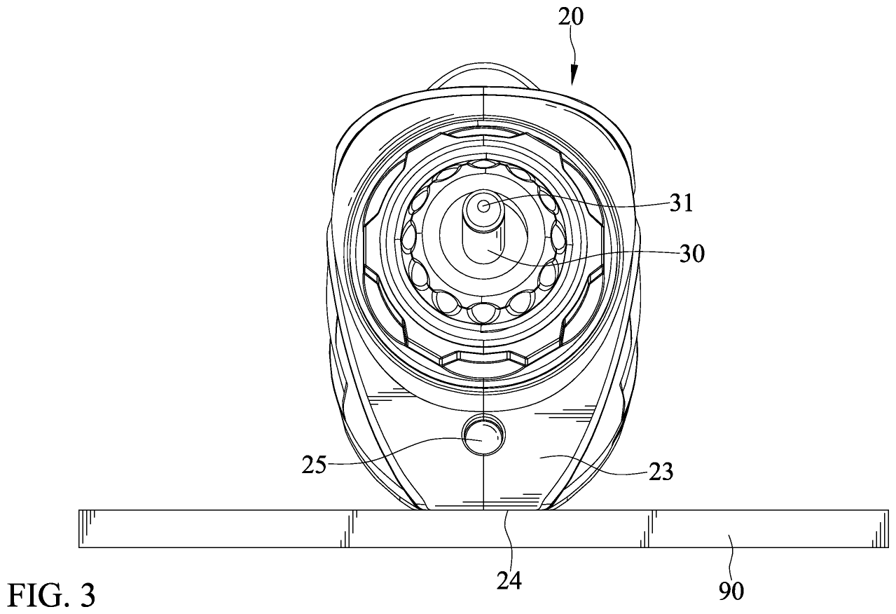

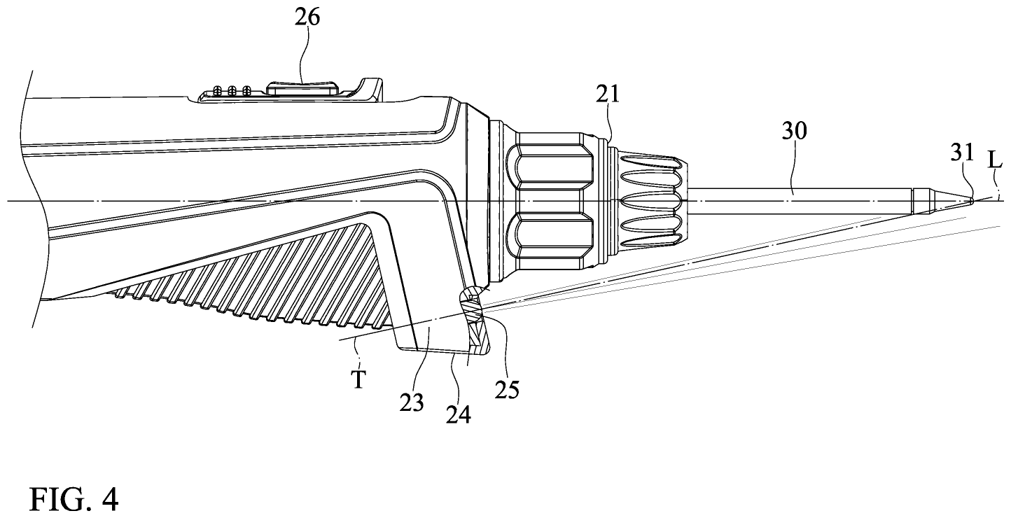

With reference to FIGS. 1-4, the self-standing tool according to the present invention includes a body 20 and a tool head 30. The body 20 extends along a longitudinal axis L and includes a front end 21 and a rear end 22 spaced from the front end 21 along the longitudinal axis L.

The body 20 further includes a lamp seat 23 projecting from an outer periphery thereof surrounding the longitudinal axis L. In this embodiment, the body 20 has an integral projection projecting therefrom to form the lamp seat 23. The lamp seat 23 is located adjacent to the front end 21. A side of the lamp seat 23 distant from the body 20 has a supporting portion 24 that is planar in this embodiment. The lamp seat 23 includes a virtual reference plane P extending perpendicularly to the longitudinal axis L and passing through the supporting portion 24. The center of gravity of the body 20 is located between the virtual reference plane P and the rear end 22. The maximum spacing between any point located between the virtual reference plane P and the rear end 22 on a side of the body 20 adjacent to the lamp seat 23 and the longitudinal axis L in a radial direction perpendicular to the longitudinal axis L is smaller than a spacing between the supporting portion 24 and the longitudinal axis L in a radial direction perpendicular to the longitudinal axis L.

A lighting member 25 is disposed on a side of the lamp seat 23 adjacent to the front end 21. The light emitted from the lighting member 25 has a virtual projection axis T. The body 20 further includes a switch 26 on the outer periphery thereof. The switch 26 is located opposite to the lamp seat 23.

The tool head 30 extend along the longitudinal axis L and includes a first end connected to the front end 21 of the body 20 and a second end distant from the body 20. The second end of the tool head 30 has a head end 31 located in a projection area of light emitted from the lighting member 25. The virtual projection axis T passes through the head end 31.

When the self-standing tool 10 is placed on a table 90, the front end 21 of the body 20 is raised by the structure of the lamp seat 23, such that the head end 31 will not contact with the table 90. Thus, the self-standing tool 10 will not roll undesirably without extra elements, effectively simplifying the structure of the self-standing tool 10. The lighting member 25 of the self-standing tool 10 emits light that is directly incident to the head end 31, providing an effective illumination. The body 20 has a simple structure and provides various functions. Accordingly, the self-standing tool 10 not only stands on its own but emits light.

A general user, either left-handed or right-handed, uses the thumb to operate the switch 26. In the use state, the lighting member 25 will be on the side of the body 20 opposite to the user while emitting light to illuminate the head end 31 and the work piece, effectively avoiding generation of shadows.

Although specific embodiments have been illustrated and described, numerous modifications and variations are still possible without departing from the scope of the invention. The scope of the invention is limited by the accompanying claims.

1. A self-standing tool comprising:
a body extending along a longitudinal axis and including a front end and a rear end spaced from the front end along the longitudinal axis, wherein the body further includes a lamp seat projecting from an outer periphery thereof surrounding the longitudinal axis, wherein a side of the lamp seat distant from the body has a supporting portion, wherein the lamp seat includes a virtual reference plane extending perpendicularly to the longitudinal axis and passing through the supporting portion, wherein a center of gravity of the body is located between the virtual reference plane and the rear end, and wherein a lighting member is disposed on a side of the lamp seat adjacent to the front end; and
a tool head including a first end connected to the front end of the body and a second end distant from the body, wherein the second end of the tool head has a head end located in a projection area of light emitted from the lighting member.

2. The self-standing tool as claimed in claim 1, wherein the light emitted from the lighting member has a virtual projection axis passing through the head end.

3. The self-standing tool as claimed in claim 1, wherein a maximum spacing between any point located between the virtual reference plane and the rear end on a side of the body adjacent to the lamp seat and the longitudinal axis in a radial direction perpendicular to the longitudinal axis is smaller than a spacing between the supporting portion and the longitudinal axis in a radial direction perpendicular to the longitudinal axis.

4. The self-standing tool as claimed in claim 1, wherein the body has an integral projection projecting therefrom to form the lamp seat.

5. The self-standing tool as claimed in claim 1, wherein the body further includes a switch on the outer periphery thereof, and wherein the switch is located opposite to the lamp seat.

6. The self-standing tool as claimed in claim 1, wherein the supporting portion is planar.

7. The self-standing tool as claimed in claim 1, wherein the lamp seat is located adjacent to the front end.

8. The self-standing tool as claimed in claim 1, wherein the tool head extends along the longitudinal axis.
